(19) United States
(12) Patent Application Publication
(10) Pub. No.: US 2025/0039889 A1
(43) Pub. Date: Jan. 30, 2025

(54) METHOD FOR RECEIVING PDCCH AND DEVICES

(71) Applicant: GUANGDONG OPPO MOBILE TELECOMMUNICATIONS CORP., LTD., Dongguan (CN)

(72) Inventors: Yi ZHANG, Dongguan (CN); Jing XU, Dongguan (CN)

(21) Appl. No.: 18/914,516

(22) Filed: Oct. 14, 2024

Related U.S. Application Data
(63) Continuation of application No. PCT/CN2022/087238, filed on Apr. 15, 2022.

(51) Int. Cl. H04W 72/23; H04L 5/00; H04W 72/0453

(52) U.S. Cl. CPC H04W 72/23; H04L 5/0005; H04W 72/0453

(57) ABSTRACT

Provided is a for receiving a physical downlink control channel (PDCCH). The method is applicable to a terminal device and includes: receiving the PDCCH on a first time unit set in a case that a first resource element is overlapped with a second resource element; wherein the first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

### CROSS-REFERENCE TO RELATED APPLICATION

This application is a continuation application of international application No. PCT/CN2022/087238, filed on Apr. 15, 2022, the entire content of which is incorporated herein by reference.

### TECHNICAL FIELD

The present disclosure relates to the field of communications, and in particular, relates to a method for receiving a physical downlink control channel (PDCCH) and devices.

### BACKGROUND

For effective use of spectrum resources, the concept of dynamic spectrum sharing (DSS) is proposed. DSS is a technology that allows simultaneous deployment of new radio (NR) and long-term evolution (LTE) in the same frequency band and allows dynamic allocation of spectrum resources between the two communication systems based on user demands.

Based on the DSS technology, related arts study how an NR PDCCH is received, and how to ensure demodulation performance of the PDCCH during reception.

### SUMMARY

Embodiments of the present disclosure provide a method and an apparatus for receiving a PDCCH, a method and an apparatus for transmitting a PDCCH, and a device and a medium thereof. The technical solutions are as follows.

According to some embodiments of the present disclosure, a method for receiving a PDCCH is provided. The method is applicable to a terminal device. The method includes:
receiving the PDCCH on a first time unit set in a case that a first resource element is overlapped with a second resource element;
wherein the first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

According to some embodiments of the present disclosure, a terminal device is provided. The terminal device includes:
a transceiver, configured to receive a PDCCH on a first time unit set in a case that a first resource element is overlapped with a second resource element;
wherein the first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

According to some embodiments of the present disclosure, a network device is provided. The network device includes:
a transceiver, configured to transmit a PDCCH on a first time unit set in a case that a first resource element is overlapped with a second resource element;
wherein the first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

### BRIEF DESCRIPTION OF DRAWINGS

For clearer descriptions of the technical solutions according to the embodiments of the present disclosure, the following briefly describes accompanying drawings required for describing the embodiments. Apparently, the accompanying drawings in the following description illustrate merely some embodiments of the present disclosure, and those of ordinary skill in the art can still derive other accompanying drawings from these accompanying drawings without creative efforts.

FIG. 1 is a schematic diagram of a 1-port CRS according to some embodiments of the present disclosure;

FIG. 2 is a schematic diagram of a frequency shift according to some embodiments of the present disclosure;

FIG. 3 is a schematic diagram of a 2-port CRS and a 4-port CRS according to some embodiments of the present disclosure;

FIG. 4 is a schematic diagram of a CRS mapping according to some embodiments of the present disclosure;

FIG. 5 is a schematic diagram of a demodulation reference signal (DMRS) mapping of a PDCCH according to some embodiments of the present disclosure;

FIG. 6 is a schematic diagram of a control resource set (CORESET) according to some embodiments of the present disclosure;

FIG. 7 is a schematic diagram of signal patterns according to some embodiments of the present disclosure;

FIG. 8 is a schematic diagram of a communication system according to some embodiments of the present disclosure;

FIG. 9 is a flowchart of a method for transmitting a PDCCH according to some embodiments of the present disclosure;

FIG. 10 is a schematic diagram of a signal overlap according to some embodiments of the present disclosure;

FIG. 11 is a schematic diagram of a signal overlap according to some embodiments of the present disclosure;

FIG. 12 is a flowchart of a method for transmitting a PDCCH according to some embodiments of the present disclosure;

FIG. 13 is a flowchart of a method for receiving a PDCCH according to some embodiments of the present disclosure;

FIG. 14 is a flowchart of a method for receiving a PDCCH according to some embodiments of the present disclosure;

FIG. 15 is a schematic diagram of a signal overlap according to some embodiments of the present disclosure;

FIG. 16 is a flowchart of a method for transmitting a PDCCH according to some embodiments of the present disclosure;

FIG. 17 is a flowchart of a method for transmitting a PDCCH according to some embodiments of the present disclosure;

FIG. 18 is a schematic diagram of a signal overlap according to some embodiments of the present disclosure;

FIG. 19 is a structural block diagram of an apparatus for receiving a PDCCH according to some embodiments of the present disclosure;

FIG. 20 is a structural block diagram of an apparatus for transmitting a PDCCH according to some embodiments of the present disclosure;

FIG. 21 is a schematic structural diagram of a terminal device according to some embodiments of the present disclosure; and

FIG. 22 is a schematic structural diagram of a network device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

First, technical knowledge involved in the embodiments of the present disclosure is briefly described hereinafter.

### Cell-Specific Reference Signal (CRS) (Description is Given Hereinafter Using an LTE CRS as an Example)

The CRS is valid for all terminal devices in a cell, and may be used for channel estimation for downlink physical channels, acquisition of channel state information (CSI), and measurement-assisted cell selection and handover.

The CRS is applicable to transmission of 1 antenna port (1 port), 2 antenna ports (2 ports), or 4 antenna ports (4 ports). The CRS is transmitted only over one or more of the 0 to 3 antenna ports. The CRS is transmitted on each downlink subframe, on each resource block (RB) throughout the entire downlink bandwidth. The CRS supports only sub-carrier spacing (SCS)=15 kHz.

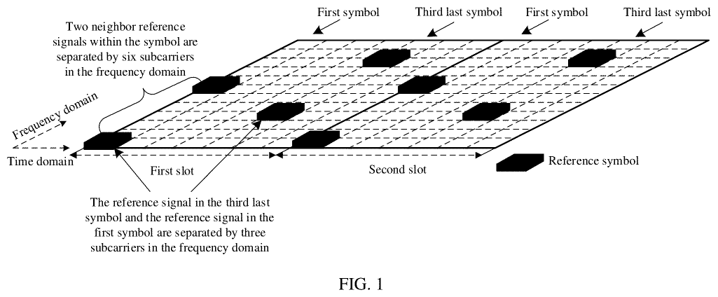

In the case that CRS is transmitted over the 1 port, the reference signal CRS is mapped to the resource element (RE) as follows. The reference signal is inserted into the first and third last orthogonal frequency division multiplexing (OFDM) symbols of each slot. Two neighbor reference signals within the same OFDM symbol are separated by six subcarriers in the frequency domain. Meanwhile, the reference signal in the third last OFDM symbol and the reference signal in the first OFDM symbol are separated by three subcarriers in the frequency domain, as shown in FIG. 1.

The start position of the reference signal within each RB is also related to a cell-specific frequency shift. In the case that six frequency shifts are defined, the frequency shift is related to the physical cell identifier (PCI) of the cell, and the frequency shift value is PCI mod 6 (which is applicable to the cases of two and four cell-specific reference signals).

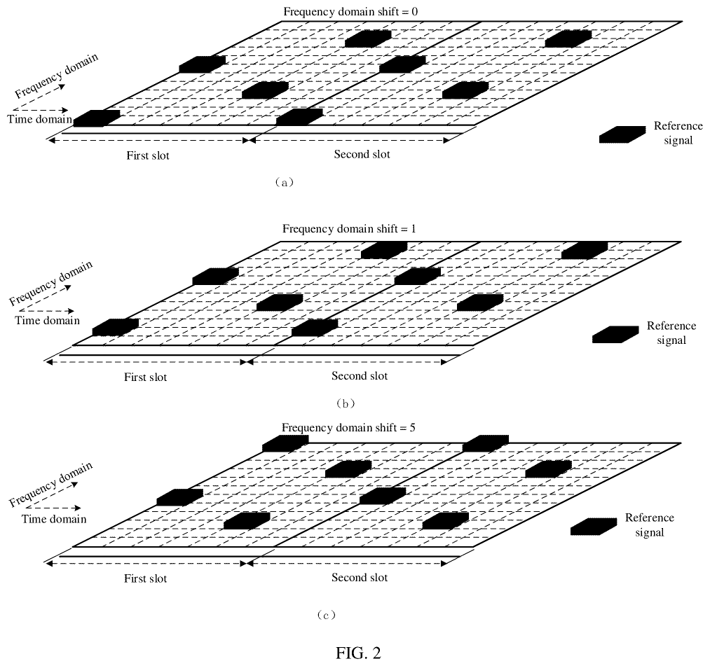

As shown in part (a) in FIG. 2, PCI mod 6 equals 0, the frequency shift equals 0, and the reference signal is inserted on the 1^{st} subcarrier and the 7^{th} subcarrier of the first OFDM symbol, and the 4^{th} subcarrier and the 10^{th} subcarrier of the third last OFDM symbol of each slot.

As shown in part (b) in FIG. 2, PCI mod 6 equals to 1, the frequency shift equals to 1, and the reference signal is inserted on the 2^{nd} subcarrier and the 8^{th} subcarrier of the first OFDM symbol, and the 5^{th} subcarrier and the 11^{th} subcarrier of the third last OFDM symbol of each slot.

As shown in part (c) in FIG. 2, PCI mod 6 equals to 5, the frequency shift equals to 5, and the reference signal is inserted on the 6^{th} subcarrier and the 12^{th} subcarrier of the first OFDM symbol, and the 3rd subcarrier and the 9^{th} subcarrier of the third last OFDM symbol of each slot.

The above frequency shifts avoid time-frequency resource conflicts between cell-specific reference signals of up to six neighbor cells.

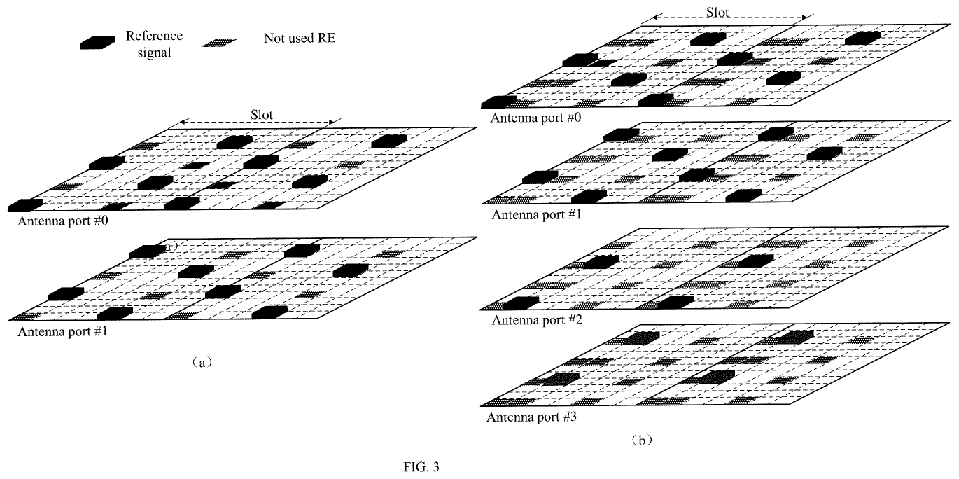

The case of extending a 1-port CRS to a 2-port or 4-port CRS is shown in FIG. 3.

2-port CRS (e.g., part (a) in FIG. 3): The reference signal on the 1^{st} antenna port (corresponding to antenna port #0) and the reference signal on the 2^{nd} antenna port (corresponding to antenna port #1), i.e., the reference signals corresponding to each of the two antenna ports are transmitted on different subcarriers of the same symbol, and are multiplexed in the frequency domain, and are shifted by three subcarriers.

4-port CRS (e.g., part (b) in FIG. 3): The reference signal on the 3rd antenna port (corresponding to antenna port #2) and the reference signal on the 4^{th} antenna port (corresponding to antenna port #3) are multiplexed in the frequency domain, and are shifted by three subcarriers in the frequency domain. The reference signals on the 3rd and 4^{th} antenna ports are transmitted on the second OFDM symbol of each slot, such that the reference signals are multiplexed with the reference signals on the 1^{st} and 2^{nd} antenna ports in the time domain. It can be seen that the 3rd antenna port (or 4th antenna port) corresponds to two reference signals and the 1^{st} antenna port (or 2^{nd} antenna port) corresponds to eight reference signals in a slot, such that the density of reference signals on the 3rd and 4^{th} antenna ports is half of the density of reference signals on the 1^{st} and 2^{nd} antenna ports.

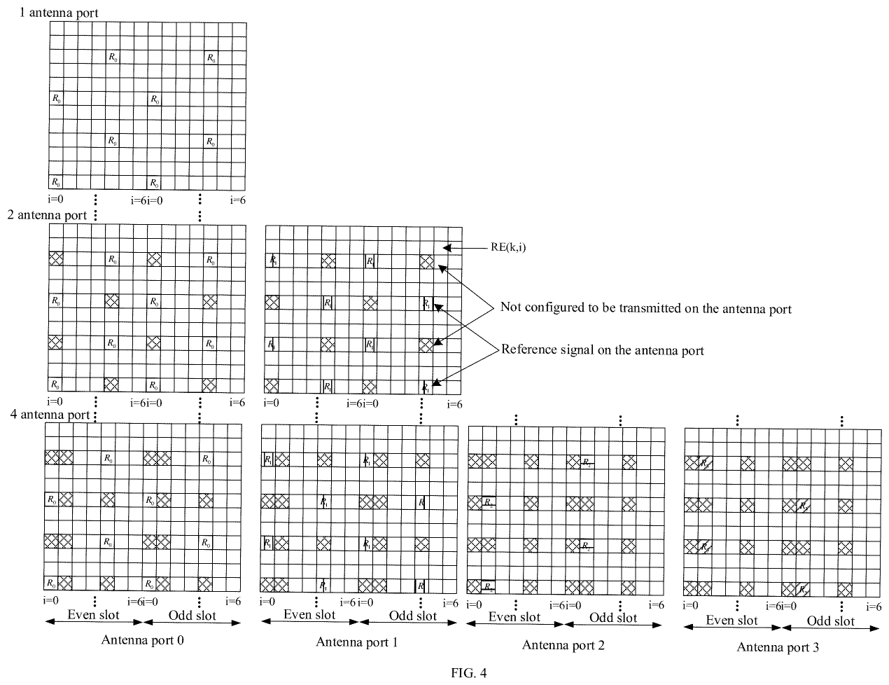

Different cyclic prefix modes affect the quantity of symbols in each slot. In normal cyclic prefixes, a slot includes seven symbols, and taking PCI mode 6=0 as an example, an example of the 1/2/4-port CRS mapping is shown in FIG. 4.

For the 1-antenna port CRS mapping, the occupied RE on the first symbol is {0, 6}.

For the 2-antenna port CRS mapping, the occupied RE on the first symbol is {0, 3, 6, 9}.

For the 4-antenna port CRS mapping, the occupied REs on the first symbol and the second symbol are {0, 3, 6, 9}.

### PDCCH and DMRS for PDCCH

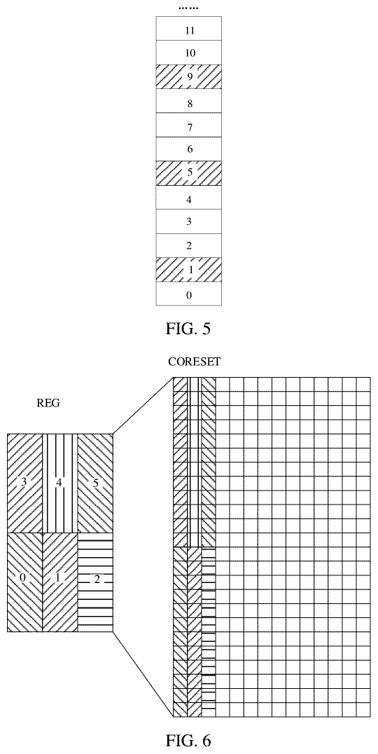

The DMRS of the PDCCH is used for channel estimation, and the terminal device demodulates the PDCCH based on the estimation of the DMRS. The DMRS density of the PDCCH is ¼, mapped to the 1^{st}, 5th, and 9^{th} REs of each RB, as shown in FIG. 5.

The concept of CORESET is introduced in the related art to correspond to the PDCCH physical resource allocation. Each cell is configured with up to 12 CORESETs, each of the CORESETs includes a group of physical resource block (PRB) in the frequency domain, a minimum granularity of the CORESET is six PRBs, and the CORESET occupies one to three OFDM symbols in the time domain. The CORESET has the concept of control channel element (CCE) and the concept of resource element group (REG). The PDCCHs are aggregated from CCEs, e.g., each PDCCH includes one, two, four, eight or sixteen CCEs. The REs in a CORESET first form a REG, each REG consists of an RB in the frequency domain and an OFDM symbol in the time domain, and the REGs in a CORESET are incrementally numbered in the order of the time domain and then the frequency domain. As shown in FIG. 6, the REGs are numbered according to the time domain, the three REGs in one frequency domain are sequentially numbered as REG 0, REG 1, and REG 2, and then the three REGs in another frequency domain are sequentially numbered according to the time domain as REG 3, REG 4, and REG 5.

Each CCE includes six REGs, the L REGs first form a REG bundle, and the mapping from CCE to REG is implemented through the REG bundle. The size L of the REG bundle is related to the symbol numbers of CORESET N_{symb}^{CORESET}. In the case that N_{symb}^{CORESET}=1, L is {2,6}, and in the case that N_{symb}^{CORESET}=2 or 3, L is {N_{symb}^{CORESET},6}. It can be seen that regardless of the quantity of CCEs in the PDCCH, the PDCCH occupies all OFDM symbols in CORESET in the time domain.

### PDCCH Reception Limitation

The following limitation is imposed on the reception of the PDCCH in the related art.

In the case that at least one RE of a PDCCH candidate is overlapped with at least one RE of the LTE CRS, the terminal device is not required to monitor the PDCCH candidate.

In the case that the precoding granularity is configured to be all contiguous RBs, the terminal device does not expect any RE of a CORESET to be overlapped with any RE of the LTE CRS.

### Dynamic Spectrum Sharing (DSS)

Considering that LTE terminals is to exist for a long time, it is very important to continue to develop DSS. The capacity of NR PDCCH is the bottleneck in the study of the work items of DSS, especially for the configuration of 4-port CRS. The NR PDCCH can only be monitored on a OFDM symbol, which undoubtedly reduces the capacity of the PDCCH. Therefore, whether the NR PDCCH can be received on the symbols of LTE CRS needs to be clarified and the impact of LTE CRS on NR PDCCH DMRS also needs to be clarified.

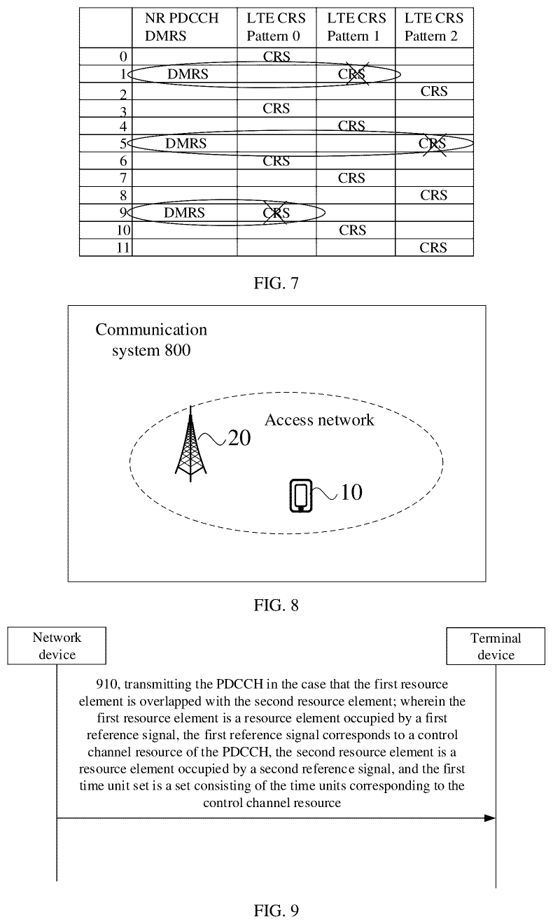

In the case that the NR PDCCH is allowed to be received on LTE CRS symbols, the impact of LTE CRS on NR PDCCH DMRS needs to be evaluated. As shown in FIG. 7, for 2-port or 4-port CRS, three types of patterns are present. From the frequency domain point, the REs occupied by the three kinds of patterns are {0, 3, 6, 9}, {1, 4, 7, 10}, and {2, 5, 8, 11} respectively, while the REs occupied by the patterns of PDCCH DMRS are {1, 5, 9}. It is apparent that a CRS RE is overlapped with a DMRS RE among the 4 CRSs, regardless of which pattern the 2-port and 4-port CRSs are configured with. Then how to design a corresponding mechanism to ensure that the demodulation performance of the PDCCH is affected as little as possible is an urgent problem to be solved.

Hereinafter, a method for receiving a PDCCH and a method for transmitting a PDCCH according to embodiments of the present disclosure are described.

FIG. 8 illustrates a schematic diagram of a communication system according to some embodiments of the present disclosure. The communication system 800 includes a terminal device 10 and an access network device 20.

The terminal device 10 is a user equipment (UE), an access terminal, a subscriber element, a subscriber station, a mobile station, a mobile platform, a remote station, a remote terminal, a mobile device, a wireless communication device, a user agent, or a user apparatus. In some embodiments, the terminal device 10 is a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal in a 5^{th} generation (5G) mobile communication system or a future evolved public land mobile network (PLMN), or the like. The type of the terminal device 10 is not limited in the embodiments of the present disclosure. For convenience of description, the devices mentioned above are collectively referred to as the terminal.

The access network device 20 is a device deployed in an access network to provide a wireless communication function for the terminal device 10. The access network device 20 may include various forms of macro base stations, micro base stations, relay stations, access points, and the like. In systems employing different radio access technologies, a device with a function of the access network device may have different names, for example, gNodeB or gNB in a 5G NR system. As a communication technology evolves, the name “access network device” may change. For convenience of description, in the embodiments of the present disclosure, apparatuses providing the wireless communication function for the terminal device 10 are collectively referred to as the access network device. In some embodiments, a communication relationship is established between the terminal device 10 and a core network device over the access network device 20. For example, in a long-term evolution (LTE) system, the access network device 20 is an evolved universal terrestrial radio access network (EUTRAN) or one or more eNodeBs in the EUTRAN. In the 5G NR system, the access network device 20 is a radio access network (RAN) or one or more gNBs in the RAN. The network device in the embodiments of the present disclosure is the access network device 20.

The “5G NR system” in the embodiments of the present disclosure may also be referred to as a 5G system or an NR system, but a person skilled in the art can understand their meanings. The technical solutions described in the embodiments of the present disclosure may be applicable to the LTE system, the 5G NR system, or an evolved system subsequent to the 5G NR system, which is not limited in the present disclosure.

FIG. 9 illustrates a flowchart of a method for transmitting a PDCCH according to some embodiments of the present disclosure. The method is applicable to a communication system as shown in FIG. 8, and the method includes the following processes.

In 910, in the case that the first resource element is overlapped with the second resource element, the network device transmits the PDCCH to the terminal device on a first time unit set; wherein the first resource element is a resource element occupied by a first reference signal, the first reference signal corresponding to a control channel resource of the PDCCH, the second resource element is a resource element occupied by a second reference signal, and the first time unit set is a set consisting of the time units corresponding to the control channel resource.

Accordingly, in the case that the first resource element is overlapped with the second resource element, the terminal device receives the PDCCH on the first time unit set; wherein the first resource element is a resource element occupied by the first reference signal, the first reference signal corresponding to a control channel resource of the PDCCH, the second resource element is a resource element occupied by the second reference signal, and the first time unit set is a set consisting of time units corresponding to the control channel resources.

In one aspect, because the resource element occupied by the first reference signal (i.e., the first resource element) is overlapped with the resource element occupied by the second reference signal (i.e., the second resource element) and the first reference signal corresponds to the control channel resource of the PDCCH, it is considered that the time units (i.e., the first time unit set) where the control channel resource is located include the time unit where the second reference signal is located, and the terminal device still receives the PDCCH on the first time unit set. Therefore, it is considered that the PDCCH is allowed to be received on the time unit where the second reference signal is located. In another aspect, because the resource element occupied by the first reference signal is overlapped with the resource element occupied by the second reference signal, and the terminal device still receives the PDCCH on the first time unit set, it is considered that the resource element occupied by the first reference signal of the control channel resources corresponding to the PDCCH is allowed to be overlapped with the resource element occupied by the second reference signal.

That is, the process 910 may be understood as allowing the PDCCH to be received on the time unit where the second reference signal is located, and allowing the resource element occupied by the first reference signal of the control channel resource corresponding to the PDCCH to be overlapped with the resource element occupied by the second reference signal.

In the embodiments of the present disclosure, the following two forms of reference signals are involved.

### First Reference Signal

The first reference signal is a reference signal corresponding to a control channel resource of the PDCCH. In a specific embodiment, the first reference signal includes a DMRS.

It should be understood that the network device configures the control channel resource, and the terminal device attempts to decode and receive the PDCCH in the configured control channel resource. The control channel resource is a resource used for the terminal device to decode and receive the PDCCH.

It should be understood that a portion of the resource element in the control channel resource is occupied by a first reference signal, and the first reference signal corresponding to the control channel resource of the PDCCH indicates that the first reference signal is a reference signal that occupies a resource in the control channel resource of the PDCCH.

It should be understood that the first resource element is related to the configuration of the control channel resource. The control channel resource includes the first resource element, and the second resource element is not related to the configuration of the control channel resource.

### Second Reference Signal

The second reference signal is a reference signal that is independent from the reception of the PDCCH.

The resource element occupied by the second reference signal is understood as: a resource element configured by the network device via at least one parameter. Accordingly, the first resource element being overlapped with the second resource element is understood as follows: the resource element occupied by the first reference signal is overlapped with the resource element configured by the network device via the at least one parameter.

In a specific embodiment, the second reference signal includes a CRS. In a specific embodiment, the resource element of the CRS is configured by the network device via a high-level parameter. The high-level parameter includes, but not limited to: a long-term evolution-cell-specific reference signal-to match around (LTE-CRS-to match around), or a long-term evolution-cell-specific reference signal-pattern list (LTE-CRS-pattern list).

In the embodiments of the present disclosure, in the case that any one of the first resource elements is the same resource element as any one of the second resource elements, the first resource element is considered to be overlapped with the second resource element.

In addition, the first resource element being overlapped with the second resource element in the embodiments of the present disclosure is understood as the resource element occupied by the first reference signal is overlapped with the resource element occupied by the second reference signal. That is, the process 910 is amended as follows: in the case that the first resource corresponding to the first reference signal is overlapped with the second resource element corresponding to the second reference signal, the network device transmits the PDCCH to the terminal device on the first time unit set; wherein the first reference signal corresponds to the control channel resource of the PDCCH, the first resource includes at least one resource element, the second resource includes at least one resource element, and the first time unit set is a set consisting of time units corresponding to the control channel resource.

The resource element includes, but is not limited to: an RE, an REG, or an RB. Accordingly, the time unit includes, but is not limited to: a symbol, a plurality of symbols, a slot, or a sub-slot. In a specific embodiment, the resource element is an RE and the time unit is a symbol. In a specific embodiment, the resource element is an RB and the time unit is a slot.

It should be understood that the first resource element herein refers to a resource element of one type, i.e., at least one resource element occupied by a first reference signal, and the first resource element includes a plurality of numbers of resource elements. The second resource element herein refers to a resource element of another type, i.e., at least one resource element occupied by a second reference signal, and the second resource element includes a plurality of numbers of resource elements. The first resource element being overlapped with the second resource element in the embodiments of the present disclosure includes: the at least one resource element occupied by the first reference signal being overlapped with the at least one resource element occupied by the second reference signal.

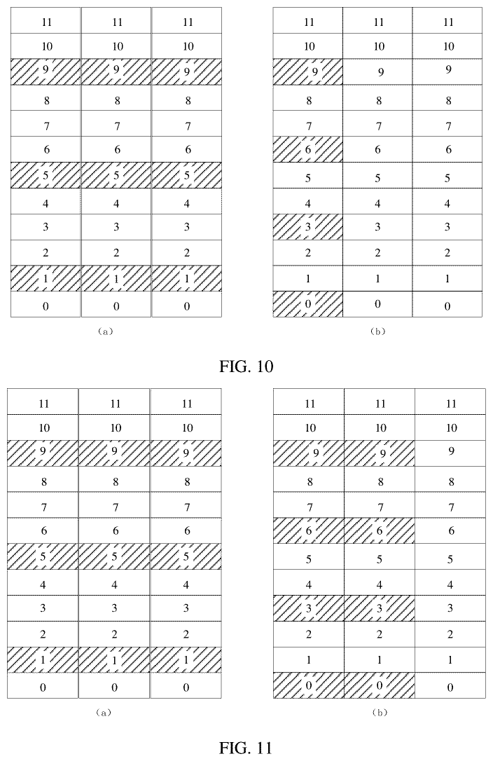

In a specific embodiment, the first resource element being overlapped with the second resource element is that a resource element occupied by the first reference signal is overlapped with a resource element occupied by the second reference signal. Referring to FIG. 10, in the case that the resource element (k, j) indicates that a resource element that is in the k^{th} time unit in the time domain and in the j^{th} frequency element in the frequency domain, the above k and j are counted from 0. Prat (a) in FIG. 10 is an example of the mapping of the first reference signal. The first resource element includes: resource element (0, 1), resource element (0, 5), resource element (0, 9), resource element (1, 1), resource element (1, 5), resource element (1, 9), resource element (2, 1), resource element (2, 5), and resource element (2, 9). Part (b) in FIG. 10 is an example of mapping of the second reference signal. The second resource element includes: resource element (0, 0), resource element (0, 3), resource element (0, 6), and resource element (0, 9). Because both the first resource element and the second resource element include the resource element (0, 9), the first resource element is considered to be overlapped with the second resource element.

In a specific embodiment, the first resource element being overlapped with the second resource element is: a plurality of resource elements occupied by the first reference signal being overlapped with a plurality of resource elements occupied by the second reference signal. Referring to FIG. 11, in the case that the resource element (k, j) indicates that a resource element is in the k^{th} time unit in the time domain and in the j^{th} frequency element in the frequency domain, the above k and j are counted from 0. Part (a) in FIG. 11 is an example of mapping of the first reference signal. The first resource element includes: resource element (0, 1), resource element (0, 5), resource element (0, 9), resource element (1, 1), resource element (1, 5), resource element (1, 9), resource element (2, 1), resource element (2, 5), and resource element (2, 9). Part (b) in FIG. 11 is an example of mapping of the second reference signal. The second resource element includes: resource element (0, 0), resource element (0, 3), resource element (0, 6), resource element (0, 9), resource element (1, 0), resource element (1, 3), resource element (1, 6), and resource element (1, 9). Because both the first resource element and the second resource element include the resource element (0, 9) and the resource element (1, 9), the first resource element is considered to be overlapped with the second resource element.

In addition, the term “overlap” in the embodiments of the present disclosure can be understood as an overlap or a collision.

In the embodiments, the first time unit set is a set consisting of time unit sets corresponding to the control channel resources. The control channel resource, from a time domain perspective, includes a plurality of time units in the time domain. The time units in the control channel resource are understood to be the time units corresponding to the control channel resources, and the set including all the time units corresponding to the control channel resources is regarded as the first time unit set.

Optionally, the PDCCH is a PDCCH of the first communication system, and the second reference signal is a reference signal of the second communication system, wherein the first communication system is an evolved system of the second communication system.

That is, the technical solutions according to the embodiments of the present disclosure can combine the concept of DSS to dynamically allocate spectrum resources between two communication systems, such that the technical solutions are applicable to the following scenario: how to perform the monitoring of the PDCCH of the first communication system in the case that resource elements mapped by reference signals in different communication systems are overlapped.

In a specific embodiment, the first communication system includes an NR, and the second communication system includes an LTE. That is., the terminal device is allowed to receive the NR PDCCH on a first time unit set in the case that the first resource element is overlapped with the second resource element. The first resource element is a resource element occupied by a first reference signal corresponding to a control channel resource of the NR PDCCH, the second resource element is a resource element occupied by the second reference signal of LTE, and the first time unit set is a set consisting of time units occupied by the control channel resources.

Optionally, the control channel resources include at least one of: a PDCCH candidate resource or a CORESET.

Optionally, in the case that a precoding granularity is configured to be all contiguous RBs, the control channel resource includes the control resource set.

The precoding granularity refers to the granularity used when performing the precoding process in the channel transmission process. In the case that the precoding granularity is configured to be all contiguous RBs, the terminal device uses all DMRSs in the control resource set to attempt to decode the PDCCH. Therefore, in the case that the precoding granularity is configured to be all contiguous RBs, the control channel resources of the PDCCH are the control resource set, whereas in the other cases, the control channel resources of the PDCCH are the PDCCH candidate resources.

In summary, the method for receiving the PDCCH according to the embodiments of the present disclosure causes the terminal device to receive a PDCCH on the first time unit set in the case that the first resource element occupied by the first reference signal of the control channel resource corresponding to the PDCCH is overlapped with the second resource element occupied by the second reference signal, and the first time unit set is a set consisting of time units occupied by the control channel resources, such that the reception of the PDCCH is ensured.

In the embodiments of the present disclosure, there are three different ways for implementing the process 910.

Implementation 1: The PDCCH is allowed to be received on the time unit where the second reference signal is located, and the resource element occupied by the first reference signal of the control channel resource corresponding to the PDCCH is also allowed to be overlapped with the resource element occupied by the second reference signal, but not all the time units of the PDCCH are allowed to be overlapped with the time unit occupied by the second reference signal.

Implementation 2: The PDCCH is allowed to be received on the time unit where the second reference signal is located, and the resource element occupied by the first reference signal of the control channel resource corresponding to the PDCCH is also allowed to be overlapped with the resource element occupied by the second reference signal, but the degree of overlap needs to be controlled.

Controlling the degree of overlap is understood as follows: in the first time unit set, a ratio of a quantity of resource elements that the first resource element is overlapped with the second resource element to a total quantity of the first resource elements not exceeding a threshold.

Implementation 3: The PDCCH is allowed to be received on the time unit where the second reference signal is located, the resource element occupied by the first reference signal of the control channel resource corresponding to the PDCCH is also allowed to be overlapped with the resource element occupied by the second reference signal, and the first reference signal is frequency domain shifted on a portion of the overlapped time units.

The first reference signal being frequency domain shifted on the portion of the overlapped time units is understood as selecting a portion of the time units from all the overlapped time units in the first time unit set, and adjusting the frequency domain elements occupied by the first reference signal on this portion of the time units.

Hereinafter, the above three implementations are further described.

Implementation 1: The PDCCH is allowed to be received on the time unit where the second reference signal is located, and the resource element occupied by the first reference signal of the control channel resource corresponding to the PDCCH is also allowed to be overlapped with the resource element occupied by the second reference signal, but not all the time units of the PDCCH are allowed to be overlapped with the time unit occupied by the second reference signal.

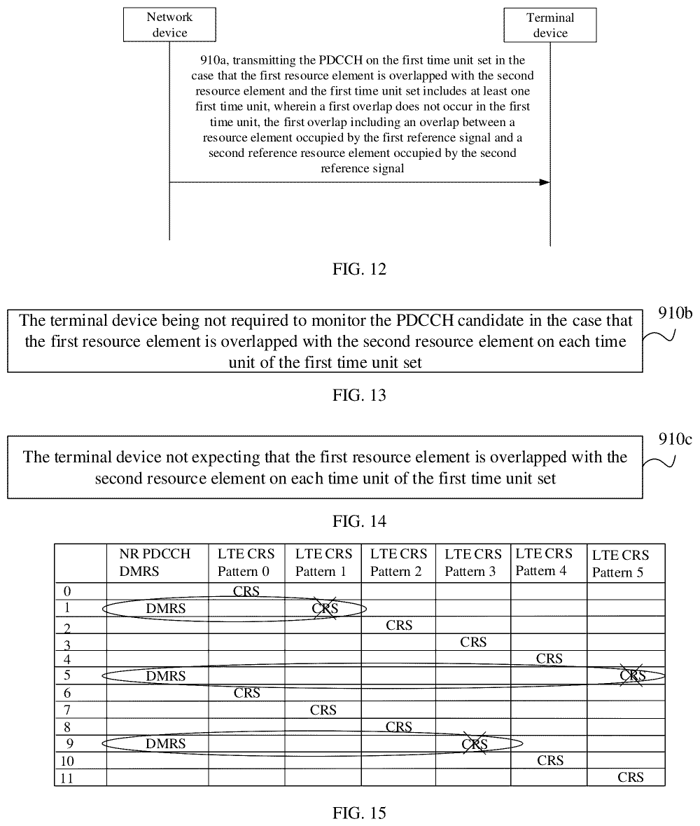

In the present implementation, process 910 is alternatively implemented as process 910a as shown in FIG. 12, or as process 910b as shown in FIG. 13, or as process 910c as shown in FIG. 14.

In 910a, the network device transmits the PDCCH to the terminal device on the first time unit set in the case that the first resource element is overlapped with the second resource element and the first time unit set includes at least one first time unit, wherein a first overlap does not occur in the first time unit, the first overlap including an overlap between a resource element occupied by the first reference signal and a second reference resource element occupied by the second reference signal.

In the case that the first resource element is overlapped with the second resource element and the first time unit set includes at least one first time unit, the terminal device receives the PDCCH on the first time unit set, wherein a first overlap does not occur in the first time unit, the first overlap including an overlap between the resource element occupied by the first reference signal and the second reference resource element occupied by the second reference signal.

It should be understood that the time unit is an element divided from a resource in a time domain, and the resource element is characterized by a particular time unit and a particular frequency domain element. A time unit including a first resource element overlapped with a second resource element indicates that a resource element characterized by the time unit is occupied by both the first reference signal and the second reference signal, or the resource element is both the first resource element as defined in embodiments of the present disclosure and the second resource element as defined in embodiments of the present disclosure.

For example, referring to FIG. 10, in the case that the resource element (k, j) indicates a resource element in the k^{th} time unit in the time domain and in the j^{th} frequency element in the frequency domain, and the above k and j are counted from 0. The time unit in the figure includes time unit 0, time unit 1 and time unit 2. Because the resource element where the overlap occurs in the figure is resource element (0, 9), the first time unit in the figure includes time unit 0.

For example, referring to FIG. 11, in the case that the resource element (k, j) indicates a resource element in the k^{th} time unit in the time domain and in the j^{th} frequency element in the frequency domain, and the above k and j are counted from 0. The time unit in FIG. 11 includes time unit 0, time unit 1 and time unit 2. Because the resource elements where the overlap occurs in FIG. 11 are resource element (0, 9) and resource element (1, 9), the first time unit in the figure includes time unit 0 and time unit 1.

In a specific embodiment, the control channel resource is a PDCCH candidate resource, and based on process 910a, in the case that the first resource element is overlapped with the second resource element and the first time unit set includes at least one first time unit, the terminal device receives the PDCCH on the first time unit set. The first resource element is a resource element occupied by a first reference signal corresponding to the PDCCH candidate resource, the second resource element is a resource element occupied by the second reference signal, the first time unit set is a set consisting of the time units corresponding to the PDCCH candidate resource. A first overlap does not occur in the first time units, wherein the first overlap includes an overlap between the resource element occupied by the first reference signal and the resource element occupied by the second reference signal.

In a specific embodiment, in the case that the precoding granularity is configured to be all contiguous RBs, the control channel resources include a control resource set, and based on process 910a, in the case that the first resource element is overlapped with the second resource element and the first time unit set includes at least one first time unit, the terminal device receives the PDCCH on the first time unit set. The first resource element is a resource element occupied by a first reference signal corresponding to the control resource set, the second resource element is a resource element occupied by the second reference signal, the first time unit set is a set consisting of the time units corresponding to the control resource set. A first overlap does not occur in the first time units, wherein the first overlap includes an overlap between the resource element occupied by the first reference signal and the resource element occupied by the second reference signal.

(2) In 910b, in the case that the first resource element is overlapped with the second resource element on each time unit of the first time unit set, the terminal device is not required to monitor the PDCCH candidate.

It should be understood that in the case that the first resource element is overlapped with the second resource element on each time unit of the first time unit set, and the terminal device being not required to monitor the PDCCH candidate indicates that the terminal device may or may not monitor the PDCCH candidate in the case that the first resource element is overlapped with the second resource element on each time unit of the first time unit set, which is not required by the protocol, or that the network device does not use the PDCCH candidate to transmit downlink control information in the case that the first resource element is overlapped with the second resource element on each time unit of the first time unit set where the PDCCH candidate is located.

In a specific embodiment, the control channel resource is a PDCCH candidate resource, and based on process 910b, the terminal device is not required to monitor the PDCCH candidate in the case that the first resource element is overlapped with the second resource element on each time unit of the first time unit set. The first resource element is a resource occupied by a first reference signal corresponding to the PDCCH candidate resource element, the second resource element is a resource element occupied by the second reference signal, and the first time unit set is a set consisting of the time units corresponding to the PDCCH candidate resource.

(3) In 910c, the terminal device does not expect that the first resource element is overlapped with the second resource element on each time unit of the first time unit set.

It should be understood that the terminal device not expecting that the first resource element is overlapped with the second resource element on each time unit of the first time unit set indicates that on each time unit of the first time unit set, the terminal device does not expect that the first resource element is overlapped with the second resource element, or in the case that the first resource element is overlapped with the second resource element on each time unit of the first time unit set, the network device does not configure the control channel resource on the first time unit set, or in the case that the control channel resource configured on the network side is subject to a situation that the first resource element is overlapped with the second resource element on each time unit of the first time unit set, the terminal device treats this situation as an error situation.

In a specific embodiment, in the case that the precoding granularity is configured to be all contiguous RBs, the control channel resources include a control resource set, and based on process 910c, the terminal device does not expect that the first resource element is overlapped with the second resource element on each time unit of the first time unit set. The first resource element is a resource element occupied by the first reference signal corresponding to the control resource set, the second resource element is a resource element occupied by the second reference signal, and the first time unit set is a set consisting of the time units corresponding to the control resource set.

It should be understood that the above processes 910a, 910b, and 910c are different expressions of the implementation 1, and their actual meanings are the same.

In summary, the method for receiving the PDCCH according to the embodiments of the present disclosure causes the terminal device to receive the PDCCH on the first time unit set in the case that the first resource element occupied by the first reference signal of the control channel resource corresponding to the PDCCH is overlapped with the second resource element occupied by the second reference signal, and the first time unit set is a set consisting of time units occupied by control channel resources, such that the reception of the PDCCH is ensured.

Meanwhile, in the method for receiving the PDCCH according to the embodiments of the present disclosure, because the first reference signal is not transmitted on the resource element in the case that the resource element occupied by the first reference signal is overlapped with the resource element occupied by the second reference signal, which results in a large frequency interval between neighbor first reference signals. By ensuring that at least one time unit is present, the resource element occupied by the first reference signal is not overlapped with the resource element occupied by the second reference signal, that is, it is ensured that the situation of the large frequency interval between neighbor first reference signals is not present in all the time units of the PDCCH, and demodulation performance of the PDCCH is ensured in the case that the first reference signal is a DMRS.

Hereinafter, the above implementation 1 is described in conjunction with specific embodiments.

In the specific embodiment, it is illustrated that the resource element is the RE, the time unit is the symbol, the first reference signal is the DMRS of the NR PDCCH, and the second reference signal is the LTE CRS. Because the control channel resource of the PDCCH occupies one to three symbols in the time domain, the mapping of the reference signals on the first three symbols is analyzed.

According to the above technical knowledge, the LTE CRS mapping on the first three symbols is as follows:

1-port CRS: {0, 6} {1, 7} {2, 8} {3, 9} {4, 10} {5, 11} (only the first symbol (symbol #0) is occupied);
2-port CRS: {0, 3, 6, 9} {1, 4, 7, 10} {2, 5, 8, 11} (only the first symbol (symbol #0) is occupied); and
4-port CRS: {0, 3, 6, 9} {1, 4, 7, 10} {2, 5, 8, 11} (the first symbol and the second symbol (symbol #0 and symbol #1) are occupied).

PDCCH DMRS pattern: the RE in each PRB is {1, 5, 9}.

Assuming that NR and LTE have the same bandwidth:

(1) According to the related art: for the 1-port CRS and the 2-port CRS, the NR PDCCH is only received on the second and third symbol, and for the 4-port CRS, the NR PDCCH is only received on the third symbol.

(2) According to implementation 1:

For the 1-port CRS:

Referring to FIG. 15, for the LTE CRS pattern {1, 7} {3, 9} {5, 11}, the PDCCH DMRS is overlapped with the LTE CRS on symbol #0. For the LTE CRS pattern {0, 6} {2, 8} {4, 10}, the PDCCH DMRS is not overlapped with the LTE CRS.

For cells with the LTE CRS pattern {1, 7} {3, 9} {5, 11}, it has same operation as the 2-port CRS below.

For cells with the LTE CRS pattern {0, 6} {2, 8} {4, 10}, the PDCCH candidate resources occupy any combination of the first three symbols, and the control resource set is configured in any combination of the first three symbols.

For the 2-port CRS:

Referring to FIG. 7, for any of the LTE CRS patterns of the 2-port CRS, the PDCCH DMRS is overlapped with the LTE CRS on symbol #0.

In the case that the PDCCH candidate resource occupies the following combination of symbols: {symbol #0}, the terminal device is not required to monitor the PDCCH candidate resource. In other words, the PDCCH candidate resource occupies the following combinations of symbols: {symbol #1}, {symbol #2}, {symbol #0, symbolic #1}, {symbol #1, symbol #2}, and {symbol #0, symbol #1, symbol #2}.

In the case that the precoding granularity is configured to be all contiguous RBs, the terminal device does not expect the control resource set to be configured in the following symbol combinations: {symbol #0}. In other words, the control resource set is configured in the following symbol combinations: {symbol #1}, {symbol #2}, {symbol #0, symbol #1}, {symbol #1, symbol #2}, and {symbol #0, symbol #1, symbol #2}.

For the 4-port CRS:

Referring to FIG. 7, for any LTE CRS patterns of the 4-port CRS, the PDCCH DMRS is overlapped with the LTE CRS on symbol #0 and symbol #1.

The terminal device is not required to monitor the PDCCH candidate resource in the case that the PDCCH candidate resource occupies the following combination of symbols: {symbol #0, symbol #1}, {symbol #0}, and {symbol #1}. In other words, the PDCCH candidate resource occupies the following combination of symbols: {symbol #2}, {symbol #1, symbol #2}, and {symbol #0, symbol #1, symbol #2}.

In the case that the precoding granularity is configured to be all contiguous RBs, the terminal device does not expect the control resource set to be configured in the following symbol combinations: {symbol #0, symbol #1}, {symbol #0}, and {symbol #1}. In other words, the control resource set is configured in the following symbol combinations: {symbol #2}, {symbol #1, symbol #2}, and {symbol #0, symbol #1, symbol #2}.

Implementation 2: The PDCCH is allowed to be received on the time unit where the second reference signal is located, and the resource element occupied by the first reference signal of the control channel resource corresponding to the PDCCH is also allowed to be overlapped with the resource element occupied by the second reference signal, but the degree of overlap needs to be controlled.

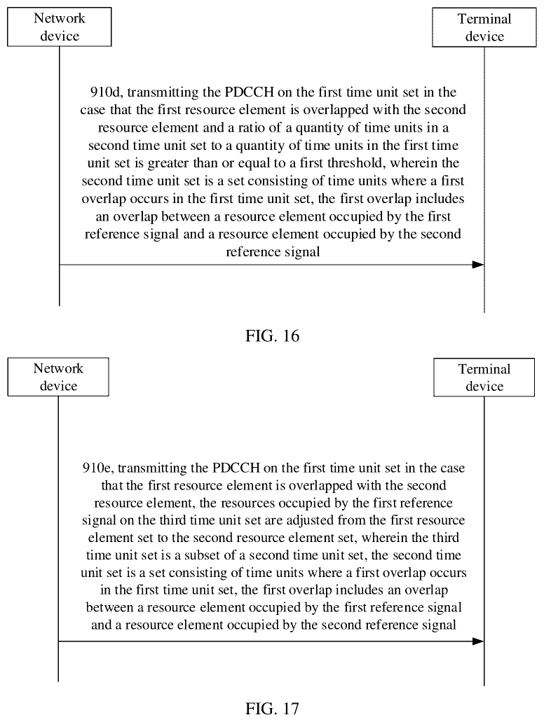

In the present implementation, the process 910 is alternatively implemented as process 910d as shown in FIG. 16.

In 910d, in the case that the first resource element is overlapped with the second resource element and a ratio of a quantity of time units in a second time unit set to a quantity of time units in the first time unit set is greater than or equal to a first threshold, the network device transmits the PDCCH on the first time unit set to the terminal device, wherein the second time unit set is a set consisting of time units where a first overlap does not occur in the first time unit set, the first overlap including an overlap between the resource element occupied by the first reference signal and the resource element occupied by the second reference signal.

Accordingly, the terminal device receives the PDCCH on the first time unit set in the case that the first resource element is overlapped with the second resource element and a ratio of a quantity of time units in a second time unit set to a quantity of time units in the first time unit set is greater than or equal to a first threshold. The second time unit set is a set consisting of time units where a first overlap occurs in the first time unit set. The first overlap includes an overlap between the resource element occupied by the first reference signal and the resource element occupied by the second reference signal.

In a specific embodiment, the control channel resource is a PDCCH candidate resource, and based on process 910d, in the case that the at least one resource element of the first reference signal corresponding to the PDCCH candidate resource is overlapped with the at least one resource element of the second reference signal and a proportion of the time units having the overlap exceeds a first threshold, the terminal device is not required to monitor the PDCCH candidate resource.

In a specific embodiment, in the case that the precoding granularity is configured to be all contiguous RBs, the control channel resources include a control resource set, and based on process 910d, the terminal device does not expect that the at least one resource element of the first reference signal corresponding to the control resource set is overlapped with the at least one resource element of the second reference signal and a proportion of the time units having overlap exceeds the first threshold.

It should be understood that the first time unit set ≥ the second time unit set, and at least one of the first time unit set and the second time unit set includes a time unit. The above comparison for the two time unit sets is made from the perspective of the quantity of time units in each time unit set.

It should be understood that the ratio of the quantity of time units in the second time unit set to the quantity of time units in the first time unit set is, alternatively, the ratio of the quantity of resource elements of the first resource element overlapped with the second resource element to the total quantity of the first resource elements.

In summary, the method for receiving the PDCCH according to the embodiments of the present disclosure causes the terminal device to receive the PDCCH on the first time unit set in the case that the first resource element occupied by a first reference signal of the control channel resource corresponding to the PDCCH is overlapped with the second resource element occupied by the second reference signal, and the first time unit set is a set consisting of time units occupied by control channel resources, such that the reception of the PDCCH is ensured.

Meanwhile, in the method for receiving the PDCCH according to the embodiments of the present disclosure, because the first reference signal is not transmitted on the resource element in the case that the resource element occupied by the first reference signal is overlapped with the resource element occupied by the second reference signal, which results in a large frequency interval between neighbor first reference signals. By controlling the proportion of time units where the overlap occurs, it is ensured that the situation of the large frequency interval between neighbor first reference signals is not present in a portion of the time units, and the demodulation performance of the PDCCH is ensured in the case that the first reference signal is a DMRS.

Hereinafter, the above implementation 2 is described in conjunction with specific embodiments.

In this specific embodiment, it is illustrated that the resource element is the RE, the time unit is the symbol, the first reference signal is the DMRS of the NR PDCCH, and the second reference signal is the LTE CRS. Because the control channel resource of the PDCCH occupies 1 to 3 symbols in the time domain, the mapping of the reference signals on the first three symbols is analyzed.

Taking the LTE CRS pattern of the 4-port CRS: {0, 3, 6, 9} {1, 4, 7, 10} {2, 5, 8, 11} (the first symbol and the second symbol (symbol #0 and symbol #1) are occupied) as an example:

(1) According to the related art: for the 4-port CRS, the NR PDCCH is only received on the third symbol.

(2) According to implementation 2:

In the case that the first threshold is set to 7/12 and the PDCCH candidate resource occupies the following combination of symbols {symbol #0, symbol #1}, {symbol #0}, {symbol #1}, and {symbol #0, symbol #1, symbol #2}, and the terminal device is not required to monitor the PDCCH candidate resource. In other words, the PDCCH candidate resource occupies the following combinations of symbols: {symbol #2}, and {symbol #1, symbol #2}. The control resource set is the same, which is not repeated herein.

This is because for the case that PDCCH candidate resources occupy {symbol #1,symbol #2}, the ratio of overlap symbols of the CRS with the DMRS is ½, which is smaller than the first threshold, and PDCCH candidate resources is monitored. In the case that the PDCCH candidate resources occupy {symbol #0, symbol #1, symbol #2}, the ratio of overlap symbols of the CRS with the DMRS is ⅔, which is larger than the first threshold, and it is not required to monitor PDCCH candidate resources.

Implementation 3: The PDCCH is allowed to be received on the time unit where the second reference signal is located, the resource element occupied by the first reference signal of the control channel resource corresponding to the PDCCH is also allowed to be overlapped with the resource element occupied by the second reference signal, and the first reference signal is frequency domain shifted on a portion of the overlapped time units.

In the present implementation, process 910 is alternatively implemented as process 910e as shown in FIG. 17.

In 910e, in the case that the first resource element is overlapped with the second resource element, the resources occupied by the first reference signal on the third time unit set are adjusted from the first resource element set to the second resource element set, and the network device transmits the PDCCH to the terminal device on the first time unit set, wherein the third time unit set is a subset of a second time unit set, the second time unit set is a set consisting of time units where a first overlap occurs in the first time unit set, the first overlap including an overlap between the resource element occupied by the first reference signal and the resource element occupied by the second reference signal.

Accordingly, in the case that the first resource element is overlapped with the second resource element, the resources occupied by the first reference signal on the third time unit set are adjusted from the first resource element set to the second resource element set, and the terminal device receives the PDCCH on the first time unit set. The third time unit set is a subset of a second time unit set, the second time unit set is a set consisting of time units where a first overlap occurs in the first time unit set. The first overlap includes an overlap between the resource element occupied by the first reference signal of the control channel resource and the resource element occupied by the second reference signal.

It should be understood that the first resource element in the above embodiments refers to a resource element occupied by the first reference signal, and the second resource element refers to a resource element occupied by the second reference signal. the first resource element set in 910e refers to all resource elements originally occupied by the first reference signal in the time domain interval of the third time unit set, and the second resource element sets refers to all resource elements originally occupied by the first reference signal in the time domain interval of the third time unit set upon a frequency domain shift.

The third time unit set is a subset of the second time unit set, which includes the case that the second time unit set is equal to the third time unit set, i.e., the third time unit set is the full set of the second time unit set.

It should be understood that the first time unit set ≥ the second time unit set ≥ the third time unit set, and at least one of the first time unit set, the second time unit set, and the third time unit set includes a time unit. The above comparison for the three time unit sets is made from the perspective of the quantity of time units in each time unit set.

In a specific embodiment, the control channel resource is a PDCCH candidate resource, and based on process 910e, in the case that the first resource element is overlapped with the second resource element, the resource occupied by the first reference signal on the third time unit set is adjusted from the first resource element set to the second resource element set, and the terminal device is allowed to receive the PDCCH on the first time unit set. The first resource element is a resource element occupied by the first reference signal of the PDCCH candidate resource corresponding to the PDCCH, the second resource element is a resource element occupied by the second reference signal, the first time unit set is a set consisting of time units occupied by the PDCCH candidate resource, the third time unit set is a subset of the second time unit set, and the second time unit set is set consisting time units where the first overlap occurs in the first time unit set. The first overlap includes an overlap between the resource element occupied by the first reference signal of the PDCCH candidate resource and the resource element occupied by the second reference signal.

In a specific embodiment, in the case that the precoding granularity is configured to be all contiguous RBs, the control channel resources include a control resource set, and based on the process 910c, in the case that the first resource elements is overlapped with the second resource elements, the resources occupied by the first reference signal on the third time unit set are adjusted from the first resource element set to the second resource element sets. The terminal device is allowed to receive the PDCCH on the first time unit set. The first resource element is a resource element occupied by the first reference signal of the control resource set corresponding to the PDCCH, the second resource element is a resource element occupied by the second reference signal, the first time unit set is a set consisting of the time units occupied by the control resource set, the third time unit set is a subset of the second time unit set, and the first overlap includes an overlap between the resource element occupied by the first reference signal of the control resource set and the resource element occupied by the second reference signal.

Optionally, performing the frequency domain shift, i.e., adjusting the resources occupied by the first reference signal on the third time unit set from the first resource element set to the second resource element set, requires to satisfy any one of the following conditions.

Condition 1: The quantity of time units in the second time unit set is equal to the quantity of time units in the first time unit set.

It should be understood that because the second time unit set consists of time units in the first time unit set, in the case that the quantity of time units in the second time unit set is equal to the quantity of time units in the first time unit set, this also indicates that the two sets are the same set.

That is, in the case that the second time unit set is equal to the first time unit set, the resources occupied by the first reference signal on the third time unit set are adjusted from the first resource element set to the second resource element set.

The second time unit set equal to the first time unit set is understood that all time units in the time units occupied by the control channel resources where the overlap occurs.

Condition 2: A ratio of the quantity of time units in the second time unit set to the quantity of time units in the first time unit set is greater than or equal to a second threshold.

That is, in the case that the ratio of the quantity of time units in the second time unit set to the quantity of time units in the first time unit set is greater than or equal to the second threshold, the resources occupied by the first reference signal on the third time unit set are adjusted from the first resource element set to the second resource element set.

A ratio of the quantity of time units in the second time unit set to the quantity of time units in the first time unit set being greater than or equal to the second threshold is understood that time units where the overlap occurs among the time units occupied by the control channel resources exceed a certain proportion.

It should be understood that the ratio of the quantity of time units in the second time unit set to the quantity of time units in the first time unit set is, alternatively, the ratio of the quantity of resource elements of the first resource element overlapped with the second resource element to the total quantity of the first resource elements.

Optionally, the above conditions 1 and 2 are further limited. In addition to the conditions 1 2, performing the frequency domain shift, i.e., adjusting the resources occupied by the first reference signals of the control channel resources on the third time unit set from the first resource element set to the second resource element sets, requires to satisfy the following condition.

Condition 3: The quantity of time units in the first time unit set is greater than 1.

That is, in the case that the quantity of time units in the first time unit set is greater than 1, the resources occupied by the first reference signal on the third time unit set are adjusted from the first resource element set to the second resource element sets.

Optionally, the above condition 3 is only for the situation that the second reference signal is a 4-port reference signal.

Optionally, determining the third time unit set from the second time unit set is performed by one of the follows.

The time units in the third time unit set are predefined by the protocol.

In a specific embodiment, a serial number of the time unit in the third time unit set is predefined in the protocol. The serial number of the time unit refers to a number of the time unit in a former level time unit, e.g., a serial number of a specified symbol in a slot is predefined in the protocol.

In a specific embodiment, time domain shifts of the time units in the third time unit set relative to the first reference time unit are predefined in the protocol.

The time domain shift is a left shift, i.e., a former time domain position, or a right shift, i.e., a later time domain position.

The first reference time unit includes a first time unit of the second time unit set, or a last time unit of the second time unit set, or a first time unit of the first time unit set, or a last time unit of the first time unit set.

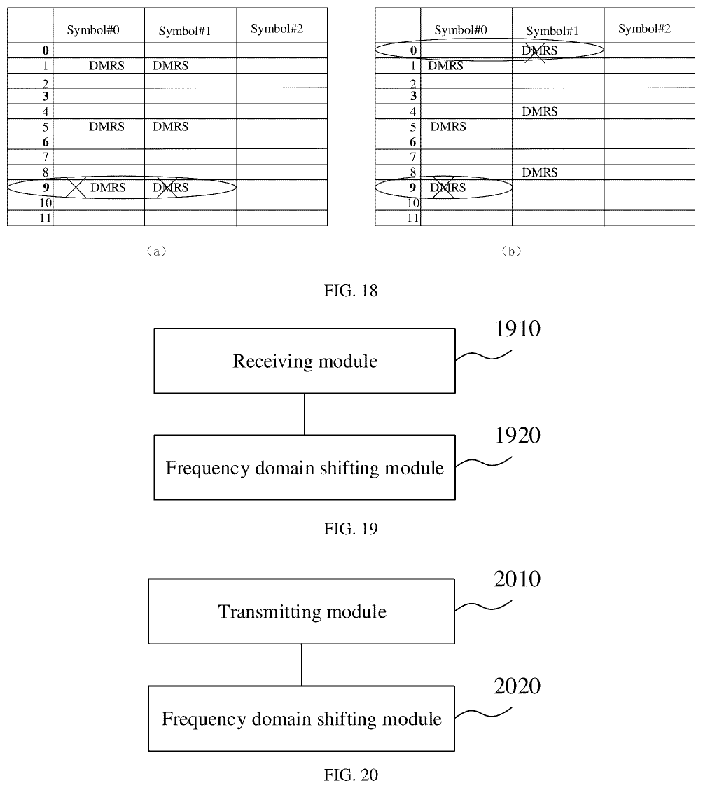

For example, referring to part (a) in FIG. 18, it is illustrated that the resource element is the RE, the time unit is the symbol, the first reference signal is the DMRS of the NR PDCCH, and the second reference signal is the LTE CRS. Because the control channel resource of the PDCCH occupies 1 to 3 symbols in the time domain, the mapping of the reference signals on the first three symbols is analyzed. Using a 4-port CRS: {0, 3, 6, 9} (occupying symbol #0 and symbol #1) of the LTE CRS pattern as an example, in the case that the control resource set is configured on {symbol #0, symbol #1}, or the PDCCH candidate resources occupy {symbol #0, symbol #1}:

The first time unit set includes: symbol #0 and symbol #1, and the second time unit set consists of the time units where the overlap occurs: symbol #0 and symbol #1.

In the case that the first reference time unit is the first time unit of the second time unit set: symbol #0, and the time domain shift includes: 1, the third time unit set includes: symbol #1.

In the case that the first reference time unit is the last time unit of the second time unit set: symbol #1, and the time domain shift includes: −1, the third time unit set includes: symbol #0.

In the case that the first reference time unit is the first time unit of the first time unit set: symbol #0, and the time domain shift includes: 1, the third time unit set includes: symbol #1.

In the case that the first reference time unit is the last time unit of the first time unit set: symbol #1, and the time domain shift includes: 0, the third time unit set includes: symbol #1.

The time units in the third time unit set are configured by the network device.

In a specific embodiment, serial numbers of the time units in the third time unit set are configured in the network device. The serial number of the time unit refers to a number of the time unit in a former level time unit, e.g., a serial number of a specified symbol in a slot configured by a high-level parameter or physical layer information at the network side. The high-level parameter includes, but is not limited to a system information block (SIB), medium access control (MAC) layer signaling, and radio resource control (RRC) layer signaling, and the physical layer information includes, but is not limited to, a physical downlink control channel (PUCCH), and a physical downlink shared channel (PUSCH).

In a specific embodiment, time domain shifts of the time units in the third time unit set relative to the first reference time unit are configured in the network device.

The time domain shift is a left shift, i.e., a former time domain position, or a right shift, i.e., a later time domain position.

The first reference time unit includes a first time unit of the second time unit set, or a last time unit of the second time unit set, or a first time unit of the first time unit set, or a last time unit of the first time unit set.

Optionally, at least one resource element of the second resource element set is shifted by X resource elements in a frequency domain relative to corresponding at least one resource element of the first resource element set, X being an integer.

X is a positive integer, i.e., an upward shift, or a negative integer, i.e., a downward shift.

Furthermore, the above at least one resource element of the second resource element set is understood as all the resource elements of the second resource element set, and the corresponding at least one resource element of the first resource element set is accordingly understood as all the resource elements of the first resource element set. That is, the second resource element set is acquired by shifting X resource elements from each resource element of the first resource element set.

Alternatively, the above at least one resource element of the second resource element set is understood as a partial resource element of the second resource element set, and the corresponding at least one resource element of the first resource element set is accordingly understood as a partial resource element of the first resource element set. That is, the second resource element set is acquired by shifting X resource elements from the partial resource elements of the first resource element set. In a specific embodiment, in the case that the DMRS of the PDCCH is partially overlapped with the LTE bandwidth, only the DMRS of the partial bandwidth that is overlapped with the LTE needs to be shifted in the frequency domain.

In summary, the method for receiving the PDCCH according to the embodiments of the present disclosure causes the terminal device to receive the PDCCH on the first time unit set in the case that the first resource element occupied by a first reference signal of the control channel resource corresponding to the PDCCH is overlapped with the second resource element occupied by the second reference signal, and the first time unit set is a set consisting of time units occupied by control channel resources, such that the reception of the PDCCH is ensured.

Meanwhile, in the method for receiving the PDCCH according to the embodiments of the present disclosure, because the first reference signal is not transmitted on the resource element in the case that the resource element occupied by the first reference signal is overlapped with the resource element occupied by the second reference signal, which results in a large frequency interval between neighbor first reference signals. The large frequency interval between neighbor first reference signals is avoided by performing the frequency domain shift, the demodulation performance of the PDCCH is ensured in the case that the first reference signal is a DMRS, and the flexibility for the configuration of the control resource set and monitoring of the PDCCH is high.

Hereinafter, the above implementation 3 is described in conjunction with specific embodiments.

In the specific embodiment, it is illustrated that the resource element is the RE, the time unit is the symbol, the first reference signal is the DMRS of the NR PDCCH, and the second reference signal is the LTE CRS. Because the control channel resource of the PDCCH occupies 1 to 3 symbols in the time domain, the mapping of the reference signals on the first three symbols is analyzed.

Using the 4-port CRS: {0, 3, 6, 9} (occupying symbol #0 and symbol #1) of the LTE CRS pattern as an example, in the case that the control resource set is configured on {symbol #0, symbol #1}, or the PDCCH candidate resources occupy {symbol #0, symbol #1}:

(1) According to the prior art: as shown in part (a) in FIG. 18, on each PRB on {symbol #0,symbol #1}, the DMRSs at RE #9 are overlapped with the CRSs, which indicates that the DMRSs are not present from RE #6 of PRB #N to RE #0 of PRB #N+1, i.e., the frequency domain interval between two neighbor DMRSs is too large, and the performance of the terminal device is inaccurate when utilizing DMRS for channel estimation/demodulation.

(2) According to implementation 3: the first time unit set is {symbol #0, symbol #1}, the second time unit set is also {symbol #0, symbol #1}, and the DMRS of the third time unit set in the second time unit set (as shown in part (b) in FIG. 18, symbol #1) is changed from the first resource element set {1, 5, 9} to the second resource element set {0, 4, 8}, such that the REs of the DMRSs being overlapped with the LTE CRS on symbol #0 and symbol #1 are different The terminal device jointly uses the DMRSs on the two symbols, when utilizing the DMRS for channel estimation/demodulation, and does not have the problem of the frequency domain interval of the neighbor DMRSs being too large, and the demodulation performance is not affected too much.

In addition to the above embodiments, the following extended embodiments are provided by present disclosure.

The PDCCH is allowed to be received on the time unit where the second reference signal is located, but the resource element occupied by the first reference signal of the control channel resource corresponding to the PDCCH is not allowed to be overlapped with the resource element occupied by the second reference signal.

In a specific embodiment, the control channel resource is a PDCCH candidate resource. Based on the embodiment, the terminal device is not required to monitor the PDCCH candidate resource in the case that at least one resource element of the first reference signal of the PDCCH candidate resource is overlapped with at least one resource element of the second reference signal.

In a specific embodiment, in the case that the precoding granularity is configured to be all contiguous RBs, and the control channel resources include a control resource set, and based on the embodiment, the terminal device does not expect that the at least one resource element of the first reference signal of the control resource set is overlapped with the at least one resource element of the second reference signal.

In summary, in the method for receiving the PDCCH according to the embodiments of the present disclosure, because the first reference signal is not transmitted on the resource element in the case that the resource element occupied by the first reference signal is overlapped with the resource element occupied by the second reference signal, which results in a large frequency interval between neighbor first reference signals. By avoiding the overlap, the first reference signal normally occupying the resource element is ensured, and the demodulation performance of the PDCCH is ensured in the case that the first reference signal is a DMRS.

Hereinafter, the above embodiments are described in conjunction with specific embodiments.

In the specific embodiment, it is illustrated that the resource element is the RE, the time unit is the symbol, the first reference signal is the DMRS of the NR PDCCH, and the second reference signal is the LTE CRS. Because the control channel resource of the PDCCH occupies 1 to 3 symbols in the time domain, the mapping of the reference signals on the first three symbols is analyzed.

Taking the LTE CRS pattern of 1-port CRS: {0, 6} {1, 7} {2, 8} {3, 9} {4, 10} {5, 11} (only the first symbol (symbol #0) is occupied) as an example:

(1) According to the prior art: for a 1-port CRS, the NR PDCCH is only received on the second and third symbols.

(2) According to the above embodiments: referring to FIG. 15, for an LTE CRS pattern {1, 7} {3, 9} {5, 11}, the PDCCH DMRS is overlapped with the LTE CRS on symbol #0. For an LTE CRS pattern {0, 6} {2, 8} {4, 10}, the PDCCH DMRS is not overlapped with the LTE CRS.

For cells with the LTE CRS pattern {1, 7} {3, 9} {5, 11}, the NR PDCCH is only received on the second and third symbols.

For cells with the LTE CRS pattern {0, 6} {2, 8} {4, 10}, the NR PDCCH is received on the third symbol. That is, the PDCCH candidate resources occupy any combination of the first three symbols, and the control resource set is configured in any combination of the first three symbols.

It should be noted that the above method embodiments are implemented separately or in combination, which is not limited in the present disclosure.

FIG. 19 illustrates a structural block diagram of an apparatus for receiving a PDCCH according to some embodiments of the present disclosure. The apparatus is implemented as a terminal device, or implemented as a portion of a terminal device, and the apparatus includes a receiving module 1910.

The receiving module 1910 is configured to allow the reception of the PDCCH on the first time unit set in the case that the first resource element is overlapped with the second resource element.

The first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

In some embodiments, the receiving module 1910 is configured to receive the PDCCH on the first time unit set in the case that the first resource element is overlapped with the second resource element and the first time unit set includes at least one first time unit, wherein a first overlap does not occur in the first time unit, the first overlap including an overlap between the resource element occupied by the first reference signal and the resource element occupied by the second reference signal; or

the receiving module 1910 is configured to be not required to monitor a PDCCH candidate in the case that the first resource element is overlapped with the second resource element on each time unit of the first time unit set; or

the receiving module 1910 is configured to not expect that the first resource element is overlapped with the second resource element on each time unit of the first time unit set.

In some embodiments, the receiving module 1910 is configured to receive the PDCCH on the first time unit set in a case that the first resource element is overlapped with the second resource element and a ratio of a quantity of time units in a second time unit set to a quantity of time units in the first time unit set is greater than or equal to a first threshold;

wherein the second time unit set is a set consisting of time units where a first overlap occurs in the first time unit set, the first overlap including an overlap between the resource element occupied by the first reference signal and the resource element occupied by the second reference signal.

In some embodiments, the apparatus further includes a frequency domain shifting module 1920, configured to adjust the resources occupied by the first reference signal on a third time unit set from a first resource element set to a second resource element set in the case that the first resource element is overlapped with the second resource element, and the receiving module 1910 is configured to receive the PDCCH on the first time unit set;

wherein the third time unit set is a subset of a second time unit set, and the second time unit set is a set consisting of time units where a first overlap occurs in the first time unit set, the first overlap including an overlap between the resource element occupied by the first reference signal and the resource element occupied by the second reference signal.

In some embodiments, the frequency domain shifting module 1920 is configured to adjust the resources occupied by the first reference signal in the third time unit set from the first resource element set to the second resource element set in a case that a quantity of time units in the second time unit set is equal to a quantity of time units in the first time unit set; or

the frequency domain shifting module 1920 is configured to adjust the resources occupied by the first reference signal in the third time unit set from the first resource element set to the second resource element set in a case that a ratio of a quantity of time units in the second time unit set to a quantity of time units in the first time unit set is greater than or equal to a second threshold.

In some embodiments, the frequency domain shifting module 1920 is configured to adjust the resources occupied by the first reference signal on the third time unit set from the first resource element set to the second resource element set in a case that to a quantity of time units in the first time unit set is greater than 1.

In some embodiments, the time units in the third time unit set are predefined in a protocol; wherein
serial numbers of the time units in the third time unit set are predefined in the protocol; or
time domain shifts of the time units in the third time unit set relative to a first reference time unit are predefined in the protocol.

In some embodiments, the time units in the third time unit set are configured by a network device; wherein
serial numbers of the time units in the third time unit set are configured in the network device; or
time domain shifts of the time units in the third time unit set relative to a first reference time unit are configured in the network device.

In some embodiments, the first reference time unit includes:
a first time unit of the second time unit set;
a last time unit of the second time unit set;
a first time unit of the first time unit set; or
a last time unit of the first time unit set.

In some embodiments, at least one resource element of the second resource element set is shifted by X resource elements in a frequency domain relative to corresponding at least one resource element of the first resource element set, X being an integer.

In some embodiments, the control channel resource includes a PDCCH candidate resource and/or a control resource set.

In some embodiments, in a case that a precoding granularity is configured as all contiguous RBs, the control channel resource includes the control resource set.

In some embodiments, the PDCCH is a PDCCH of a first communication system; and the second reference signal is a reference signal of a second communication system;
wherein the first communication system is an evolved system of the second communication system.

In some embodiments, the first reference signal includes a DMRS; and
the second reference signal includes a CRS.

FIG. 20 illustrates a structural block diagram of an apparatus for transmitting the PDCCH according to some embodiments of the present disclosure. The apparatus is implemented as a network device, or implemented as a portion of a network device, and the apparatus includes a transmitting module 2010.

The transmitting module 2010 is configured to transmit the PDCCH on a first time unit set in the case that the first resource element is overlapped with the second resource element.

The first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

In some embodiments, the transmitting module 2010 is configured to transmit the PDCCH on the first time unit set in the case that the first resource element is overlapped with the second resource element and the first time unit set includes least one first time unit in, wherein a first overlap does not occur in the first time unit, the first overlap including an overlap between the resource element occupied by the first reference signal and the resource element occupied by the second reference signal.

In some embodiments, the transmitting module 2010 is configured to transmit the PDCCH on the first time unit set in the case that the first resource element is overlapped with the second resource element and a ratio of a quantity of time units in a second time unit set to a quantity of time units in the first time unit set is greater than or equal to a first threshold;

wherein the second time unit set is a set consisting of time units where a first overlap occurs in the first time unit set, the first overlap includes an overlap between the resource element occupied by the first reference signal and the resource element occupied by the second reference signal.

In some embodiments, the device further includes a frequency domain shifting module 2020, configured to adjust resources occupied by the first reference signal on a third time unit set from a first resource element set to a second resource element set in the case that the first resource element is overlapped with the second resource element, the transmitting module 2010 is configured to transmit the PDCCH on the first time unit set;

wherein the third time unit set is a subset of a second time unit set, and the second time unit set is a set consisting of time units where a first overlap occurs in the first time unit set, the first overlap including an overlap between the resource element occupied by the first reference signal and the resource element occupied by the second reference signal.

In some embodiments, the frequency domain shifting module 2020 is configured to adjust the resources occupied by the first reference signal in the third time unit set from the first resource element set to the second resource element set in a case that a quantity of time units in the second time unit set is equal to a quantity of time units in the first time unit set; or

the frequency domain shifting module 2020 is configured to adjust the resources occupied by the first reference signal in the third time unit set from the first resource element set to the second resource element set in a case that a ratio of a quantity of time units in the second time unit set to a quantity of time units in the first time unit set is greater than or equal to a second threshold.

In some embodiments, the frequency domain shifting module 2020 is configured to adjust the resources occupied by the first reference signal on the third time unit set from the first resource element set to the second resource element set in a case that a quantity of time units in the first time unit set being greater than 1.

In some embodiments, the time units in the third time unit set are predefined by a protocol; wherein
a serial numbers of the time units in the third time unit set are predefined in the protocol; or
a time domain shifts of the time units in the third time unit set relative to a first reference time unit are predefined in the protocol.

In some embodiments, the time units in the third time unit set are configured by the apparatus; wherein
serial numbers of the time units in the third time unit set are configured in the network device; or
time domain shifts of the time units in the third time unit set relative to a first reference time unit are configured in the network device.

In some embodiments, the first reference time unit includes:
a first time unit of the second time unit set;
a last time unit of the second time unit set;
a first time unit of the first time unit set; or
a last time unit of the first time unit set.

In some embodiments, the at least one resource element of the second resource element set is shifted by X resource elements in a frequency domain relative to corresponding at least one resource element of the first resource element set, X being an integer.

In some embodiments, the control channel resource includes a PDCCH candidate resource and/or a control resource set.

In some embodiments, in a case that a precoding granularity is configured as all contiguous RBs, the control channel resource includes the control resource set.

In some embodiments, the PDCCH is a PDCCH of a first communication system; and the second reference signal is a reference signal of a second communication system;

wherein the first communication system is an evolved system of the second communication system.

In some embodiments, the first reference signal includes a DMRS; and the second reference signal includes a CRS.

It should be noted that in the case that the apparatus provided in the foregoing embodiments performs its functions, division of the functional modules is merely used as an example. In practice, the foregoing functions may be allocated to and completed by different functional modules as required, that is, an internal structure of the apparatus is divided into different functional modules to complete all or some of the foregoing functions.

Specific manners of performing operations by the modules in the apparatus in the foregoing embodiments have been described in detail in the embodiments of the related method, which are not described herein any further.

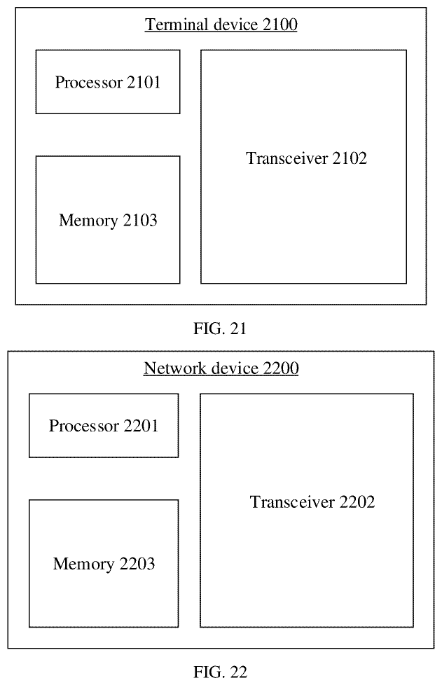

FIG. 21 illustrates a schematic structural diagram of a terminal device according to some embodiments of the present disclosure. The terminal device 2100 includes a processor 2101, a transceiver 2102, and a memory 2103.

The processor 2101 includes one or more processing cores. The processor 2101 runs a software program and module to execute various functional applications.

The transceiver 2102 may be configured to receive and transmit information. The transceiver 2102 may be a communication chip.

The memory 2103 may be configured to store at least one computer program. The processor 2101, when loading and running the at least one computer program, is caused to perform each process performed by the terminal device in the method embodiments.

In addition, the memory 2103 may be implemented by any type of volatile or non-volatile storage device or a combination thereof. The volatile or non-volatile storage device includes but is not limited to a random-access memory (RAM), a read-only memory (ROM), an erasable programmable ROM (EPROM), an electrically EPROM (EEPROM), a flash memory or another solid-state storage technology, a compact disc ROM (CD-ROM), a high-density digital video disc (DVD) or another optical memory, a magnetic tape cartridge, a magnetic tape, a disk memory, or another magnetic memory device.

The processor 2101 and the transceiver 2102 involved in the embodiments of the present disclosure may perform the processes performed by the terminal device in any method illustrated in the foregoing embodiments, which are not described herein any further.

Optionally, the transceiver 2102 is configured to receive a PDCCH on a first time unit set in the case that the first resource element is overlapped with the second resource element;

wherein the first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

The transceiver 2102 is configured to implement a function corresponding to the receiving module 1910 in FIG. 19 or to perform an operation corresponding to the receiving module 1910, and the processor 2101 is configured to implement at least a function corresponding to the frequency domain shifting module 1920 in FIG. 19 or to perform an operation corresponding to the frequency domain shifting module 1920.

FIG. 22 illustrates a schematic structural diagram of a network device according to some embodiments of the present disclosure. The network device 2200 includes a processor 2201, a transceiver 2202, and a memory 2203.

The processor 2201 includes one or more processing cores. The processor 2201 runs a software program and module to execute various functional applications.

The transceiver 2202 may be configured to receive and transmit information. The transceiver 2202 may be a communication chip.

The memory 2203 may be configured to store at least one computer program. The processor 2201, when loading and running the at least one computer program, is caused to perform each process performed by the network device in the method embodiments.

In addition, the memory 2203 may be implemented by any type of volatile or non-volatile storage device or a combination thereof. The volatile or non-volatile storage device includes but is not limited to a RAM, a ROM, an EPROM, an EEPROM, a flash memory or another solid-state storage technology, a CD-ROM, a high-density DVD or another optical memory, a magnetic tape cartridge, a magnetic tape, a disk memory, or another magnetic memory device.

The processor 2201 and the transceiver 2202 involved in the embodiments of the present disclosure may perform the processes performed by the network device in any method illustrated in the foregoing embodiments, which are not described herein any further.

Optionally, the transceiver 2202 is configured to transmit a PDCCH on a first time unit set in the case that the first resource element is overlapped with the second resource element;

wherein the first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

The transceiver 2202 is configured to implement a function corresponding to the transmitting module 2010 in FIG. 20 or to perform an operation corresponding to the transmitting module 2010, and the processor 2201 is configured to implement at least a function corresponding to the frequency domain shifting module 2020 in FIG. 20 or to perform an operation corresponding to the frequency domain shifting module 2020.

In some embodiments, a computer-readable storage medium is further provided. The computer-readable storage medium stores at least one instruction, at least one program, a code set, or an instruction set. The at least one instruction, the at least one program, the code set, or the instruction set, when loaded and executed by a processor, causes the processor to perform the method for receiving the PDCCH or the method for transmitting the PDCCH according to the above method embodiments.

In some embodiments, a chip is further provided. The chip includes a programmable logic circuit and/or a program instruction. When running on a terminal device or network device, the chip is caused to perform the method for receiving the PDCCH or the method for transmitting the PDCCH according to the above aspects.

In some embodiments, a computer program product is further provided. The computer program product, when run on a processor of a computer device, causes the processor to perform the method receiving the PDCCH or the method for transmitting the PDCCH according to the above aspects.

Those of ordinary skill in the art can understand that all or some of the processes in the foregoing embodiments may be performed by hardware, or by instructing related hardware using a program. The program may be stored in a computer-readable storage medium. The storage medium may be a read-only memory, a disk, a compact disc, or the like.

It should be understood that the terms “system” and “network” herein are interchangeably used in the present disclosure. The term “and/or” herein merely indicates an association relationship describing associated objects, that is, three types of relationships. For example, the phrase “A and/or B” indicates (A), (B), or (A and B). In addition, the character “/” generally indicates an “or” relationship between the associated objects. It is understandable that the term “indicate” in the embodiments of the present disclosure means a direct indication, an indirect indication, or an associated relationship. For example, A indicating B, which mean that A indicates B directly, e.g., B is acquired by A; or that A indicates B indirectly, e.g., A indicates C, wherein B is acquired by C; or that an association relationship is present between A and B. It is understandable that the term “corresponding” may indicate a direct corresponding relationship or indirect corresponding relationship between two objects, or indicate an association relationship between two objects, or indicate relationships such as indicating and being indicated, configuring and being configured, or the like. It is understandable that the “predefined,” “protocol agreement,” “predetermined,” or “a predefined rule” is implemented by pre-storing a corresponding code, a table, or another manner that may indicate related information in the device (for example, the terminal device or the network device), and the specific implementations are not limited in the present disclosure. For example, the term “predefined” refers to defined in a protocol. It is understandable that the term “protocol” indicates a standard protocol in the field of communications. For example, the protocols include the LTE protocol, the NR protocol, and related protocols applied to the future communication system, which are not limited in the present disclosure.

Described above are merely embodiments of the present disclosure and are not intended to limit the present disclosure. Any modification, equivalent replacement, and improvement within the spirit and principle of the present disclosure shall be included within the protection scope of the present disclosure.

1. A method for receiving a physical downlink control channel (PDCCH), applicable to a terminal device, the method comprising:
receiving the PDCCH on a first time unit set in a case that a first resource element is overlapped with a second resource element;
wherein the first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

2. The method according to claim 1, wherein receiving the PDCCH on the first time unit set in the case that the first resource element is overlapped with the second resource element comprises:
receiving the PDCCH on the first time unit set in a case that the first resource element is overlapped with the second resource element and the first time unit set comprises at least one first time unit, wherein a first overlap does not occur in the first time unit, the first overlap comprising an overlap between a resource element occupied by the first reference signal and a resource element occupied by the second reference signal; or
being not required to monitor a PDCCH candidate in a case that the first resource element is overlapped with the second resource element on each time unit of the first time unit set; or
not expecting that the first resource element is overlapped with the second resource element on each time unit of the first time unit set.

3. The method according to claim 1, wherein receiving the PDCCH on the first time unit set in the case that the first resource element is overlapped with the second resource element comprises:
receiving the PDCCH on the first time unit set in a case that the first resource element is overlapped with the second resource element and a ratio of a quantity of time units in a second time unit set to a quantity of time units in the first time unit set is greater than or equal to a first threshold;
wherein the second time unit set is a set consisting of time units where a first overlap occurs in the first time unit set, the first overlap comprising an overlap between the resource element occupied by the first reference signal and the resource element occupied by the second reference signal.

4. The method according to claim 1, wherein receiving the PDCCH on the first time unit set in the case that the first resource element is overlapped with the second resource element comprises:
adjusting resources occupied by the first reference signal on a third time unit set from a first resource element set to a second resource element set, and receiving the PDCCH on the first time unit set in the case that the first resource element is overlapped with the second resource element;
wherein the third time unit set is a subset of a second time unit set, and the second time unit set is a set consisting of time units where a first overlap occurs in the first time unit set, the first overlap comprising an overlap between the resource element occupied by the first reference signal and the resource element occupied by the second reference signal.

5. The method according to claim 4, wherein adjusting the resources occupied by the first reference signal on the third time unit set from the first resource element set to the second resource element set comprises:
adjusting the resources occupied by the first reference signal in the third time unit set from the first resource element set to the second resource element set in a case that a quantity of time units in the second time unit set is equal to a quantity of time units in the first time unit set; or
adjusting the resources occupied by the first reference signal in the third time unit set from the first resource element set to the second resource element set in a case that a ratio of a quantity of time units in the second time unit set to a quantity of time units in the first time unit set is greater than or equal to a second threshold.

6. The method according to claim 4, wherein adjusting the resources occupied by the first reference signal on the third time unit set from the first resource element set to the second resource element set comprises:
adjusting the resources occupied by the first reference signal on the third time unit set from the first resource element set to the second resource element set in a case that to a quantity of time units in the first time unit set is greater than 1.

7. The method according to claim 4, wherein at least one resource element of the second resource element set is shifted by X resource elements in a frequency domain relative to corresponding at least one resource element of the first resource element set, X being an integer.

8. The method according to claim 1, wherein the control channel resource comprises at least one of a PDCCH candidate resource or a control resource set.

9. The method according to claim 1, wherein
the first reference signal comprises a demodulation reference signal (DMRS); and
the second reference signal comprises a cell-specific reference signal (CRS).

10. The method according to claim 9, wherein a resource element of the CRS is configured by the network device via a high-level parameter, the high-level parameter comprises a long-term evolution-cell-specific reference signal-to match around (LTE-CRS-to match around), or a long-term evolution-cell-specific reference signal-pattern list (LTE-CRS-pattern list).

11. A terminal device, comprising:
a transceiver, configured to receive a physical downlink control channel (PDCCH) on a first time unit set in a case that a first resource element is overlapped with a second resource element;
wherein the first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

12. The terminal device according to claim 11, wherein the transceiver is further configured to:
receive the PDCCH on the first time unit set in a case that the first resource element is overlapped with the second resource element and the first time unit set comprises at least one first time unit, wherein a first overlap does not occur in the first time unit, the first overlap comprising an overlap between a resource element occupied by the first reference signal and a resource element occupied by the second reference signal; or
be not required to monitor a PDCCH candidate in a case that the first resource element is overlapped with the second resource element on each time unit of the first time unit set; or
not expect that the first resource element is overlapped with the second resource element on each time unit of the first time unit set.

13. The terminal device according to claim 11, wherein the control channel resource comprises at least one of a PDCCH candidate resource or a control resource set.

14. The terminal device according to claim 11, wherein
the first reference signal comprises a demodulation reference signal (DMRS); and
the second reference signal comprises a cell-specific reference signal (CRS).

15. The terminal device according to claim 14, wherein a resource element of the CRS is configured by the network device via a high-level parameter, the high-level parameter comprises a long-term evolution-cell-specific reference signal-to match around (LTE-CRS-to match around), or a long-term evolution-cell-specific reference signal-pattern list (LTE-CRS-pattern list).

16. A network device, comprising:
a transceiver, configured to transmit a physical downlink control channel (PDCCH) on a first time unit set in a case that a first resource element is overlapped with a second resource element;
wherein the first resource element is a resource element occupied by a first reference signal, the first reference signal corresponding to a control channel resource of the PDCCH, the second resource element is a resource element occupied by a second reference signal, and the first time unit set is a set consisting of time units corresponding to the control channel resource.

17. The network device according to claim 16, wherein the transceiver is further configured to:
transmit the PDCCH on the first time unit set in a case that the first resource element is overlapped with the second resource element and the first time unit set comprises at least one first time unit, wherein a first overlap does not occur in the first time unit, the first overlap comprising an overlap between the resource element occupied by the first reference signal and the resource element occupied by the second reference signal.

18. The network device according to claim 16, wherein the control channel resource comprises at least one of a PDCCH candidate resource or a control resource set.

19. The network device according to claim 16, wherein
the first reference signal comprises a demodulation reference signal (DMRS); and
the second reference signal comprises a cell-specific reference signal (CRS).

20. The network device according to claim 19, wherein a resource element of the CRS is configured by the network device via a high-level parameter, the high-level parameter comprises a long-term evolution-cell-specific reference signal-to match around (LTE-CRS-to match around), or a long-term evolution-cell-specific reference signal-pattern list (LTE-CRS-pattern list).
